(19) United States
(12) Patent Application Publication
(10) Pub. No.: US 2020/0346650 A1
(43) Pub. Date: Nov. 5, 2020

(54) METHOD FOR COMPENSATING FOR WHEEL TORQUE INTERRUPTION IN THE EVENT OF A CHANGE IN THE BRAKING RATIO

(71) Applicant: RENAULT s.a.s., Boulogne-Billancourt (FR)

(72) Inventors: Cedric CHANTREL, Charenton Le Pont (FR); Marco MARSILIA, Cachan (FR)

(73) Assignee: RENAULT s.a.s., Boulogne-Billancourt (FR)

(21) Appl. No.: 16/463,942

(22) PCT Filed: Sep. 21, 2017
(86) PCT No.: PCT/FR2017/052531

§ 371 Date: May 24, 2019

(30) Foreign Application Priority Data
Dec. 2, 2016 (FR) 1661867

(51) Int. Cl. B60W 30/19; B60W 10/08; B60W 10/11; B60W 10/184; B60W 20/15; B60K 6/48; B60W 30/18

(52) U.S. Cl. CPC B60W 30/19; B60W 10/08; B60W 10/11; B60W 10/184; B60W 20/15; B60Y 2300/89; B60W 30/18127; B60K 2006/4841; B60W 2710/1005; B60W 2710/18; B60K 6/48

(57) ABSTRACT

A method compensates for wheel torque interruption for a change in braking ratio in a vehicle with an electric traction unit linked to wheels by a gearbox that transmits, to the wheels, the braking torque of the electric traction unit in the deceleration phase over at least two transmission ratios, and a mechanical braking system acting on the wheels independently of the electric traction unit. The method includes defining a setpoint for mechanical braking torque at the wheels, depending on the control type of the electric traction unit, and the date of the downshift ratio change request to the gearbox. The mechanical braking torque setpoint is equal to the difference between an anticipated torque request to the electric traction unit and the estimation of the torque at the wheel, before the date of the end of the shift at the gearbox, if the electric traction unit is torque-controlled.

The present invention relates to the control of the torque of an electric traction machine in a phase of change of ratio in braking, in an electric or hybrid architecture that does not make it possible to ensure, during changes change of ratio in pure electric mode, the coupling to the wheel of an electrical source of regenerative torque.

More specifically, the subject of the present invention is a method for compensating for an interruption of torque at the wheel in the event of a change of ratio in braking, on a vehicle having an electric traction machine linked to the wheels of the vehicle by a gearbox that can transmit to the wheels the braking torque of the electric machine in a phase of deceleration over at least two transmission ratios, and a mechanical braking system acting on the wheels independently of the electric machine.

Through the publication FR 2 973 299, a hybrid architecture is known that has two pure electric ratios, between which the shifts are performed by displacing a sliding gear. After being declutched, the sliding gear goes through an intermediate neutral position, in which no torque from the electric traction machine is transmitted to the wheel, before being clutched on the opposite side.

This type of transmission means that, during a phase of braking ensured by an electric motor, there is observed, on an electric ratio shift in ZEV (Zero Emission Vehicle) mode, an interruption of torque to the wheel. The braking torque of the electric motor is then no longer transmitted to the wheels. Furthermore, in order to allow the declutching in the initial phase of the change of ratio, it is necessary to cancel the torque supplied by the electric motor in order to reduce the torque exerted on the clutch. This cancelation of torque has a direct impact on the braking torque at the wheel, which is very poorly perceived by the user.

The present invention aims to compensate for the lack of braking torque at the wheel, both during the phase of cancelation of torque in the preparation for declutching, but also during the change of ratio using the braking system of the vehicle.

To this end, it proposes defining a mechanical braking torque setpoint at the wheels, which is a function of the type of control of the electric machine, and of the time of request for a ratio downshift to the box.

This invention is primarily, but not exclusively, applicable to any vehicle whose gearbox does not make it possible to ensure the coupling to the wheel of an electric source of regenerative torque, during the changes of ratio in electric mode.

The present invention will be better understood on reading the following description of a nonlimiting embodiment thereof, by referring to the attached drawings, in which:

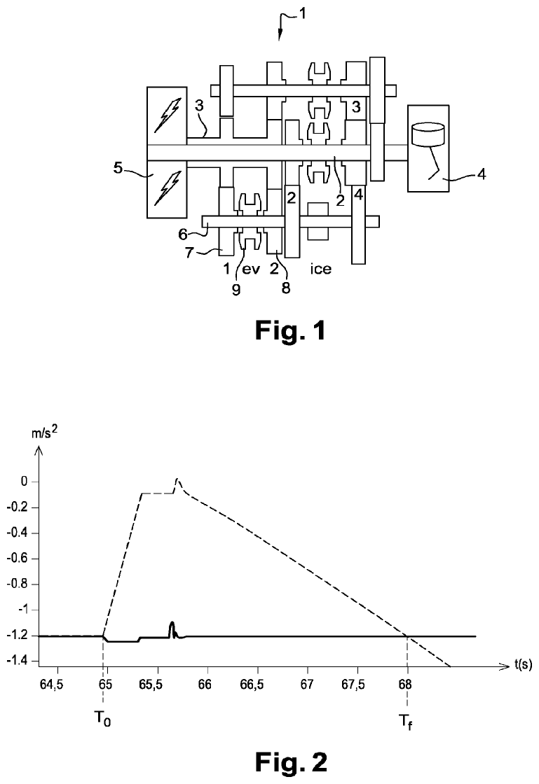

FIG. 1 is a simplified diagram of a gearbox concerned, and

FIG. 2 illustrates the application of the invention.

FIG. 1 summarily represents the architecture of a hybrid transmission 1 with four ratios comprising two concentric primary shafts 2, 3, linked respectively to an internal combustion engine 4 and to an electric traction machine 5. The secondary shaft 6 bears two idle gears 7, 8, making it possible to establish two first electric ratios according to the position of the sliding gear 9, when the internal combustion engine is not connected to the transmission.

During changes of ratio in “pure” electric mode between the ratios 1 and 2, the transmission of the torque to the wheels is interrupted. Such is the case in traction phase, but also in “regenerative” braking phase, in which the electric machine transmits a braking torque to the wheel. Upon a change between these two ratios in “regenerative” braking mode, there is an interruption of the braking torque, when the sliding gear 8 goes through its intermediate neutral position. The declutching does not take effect at the very instant of the ratio change request, but its preparation begins instantaneously.

Considering a control system of the electric machine during these transition phases, its main inputs are as follows:

ME_Tq_sp: torque setpoint of the main electric machine in Nm,

ME_Tq_esti: estimation of the torque produced by the main electric machine in Nm,

DLS_tgt: requested gear ratio; at the instant of a ratio upshift (or downshift) request T0, the requested gear ratio signal DLS_tgt changes, for example, from the value 2 to the value 1, or from 1 to 2. The instant at which the change of ratio ends is Tf,

SCM_Ctrl_typ: type of control of the gearbox: for example no control, torque control or speed control.

To compensate for the failure of the braking torque of the electric machine 5, the invention aims to impose on the main braking system of the vehicle a mechanical braking torque setpoint, denoted BRK_Tq_sp. This setpoint is expressed in Nm. Its value, imposed on the main braking system, by the proposed method, is the output datum thereof.

The torque setpoint of the electric machine 5 (called main electric machine under the assumption that the transmission can also receive energy input from secondary electric machines) is denoted ME_Tq_sp(t). The torque setpoint related to the wheel, ME_Tq_sp_whl, is linked to the torque setpoint of the electric machine ME_Tq_sp(t) by the transmission ratio ME_ratio_whl(t) between the machine and the wheel, according to the relationship:

ME_Tq_sp_whl(t)=ME_Tq_sp(t)*ME_ratio_whl(t).

The estimation of the torque produced by the main electric machine related to the wheel ME_Tq_esti_whl can be defined likewise from the estimation of the torque produced by the electric machine, as the product of an estimation of the torque produced by the electric machine ME_Tq_esti(t) by the same reduction ratio to the wheels ME_ratio_whl:

ME_Tq_esti_whl(t)=ME_Tq_esti(t)*ME_ratio_whl(t).

To take account of a delay 0 <t delay <=is between the sending of a torque setpoint of the main electric machine related to the wheel and its actual application, there is defined a delayed torque setpoint related to the wheel, ME_Tq_sp_whl_delay, such that ME_Tq_sp_whl_delay(t)=ME_Tq_Sp_whl (t−t_delay) with 0<t_delay<=1 second. Then, a delay coefficient α is defined, such that:

α(t)=(ME_Tq_sp_whl(t)−ME_Tq-sq_wl_delay(t))/t_delay

By virtue of the coefficient a, it is possible to define a setpoint of anticipated torque of the main electric machine related to the wheel ME_Tq_sp_whl_ant such that:

ME_Tq_sp_whl_ant(t)=Int(α(T0)),

in which Int is a discrete integral initialized at the instant T0, with, as initial condition,

ME_Tq_sp_whl(T0). The anticipated torque setpoint of the electric machine related to the wheel (ME_Tq_sp_whl_ant), is thus defined from the torque setpoint related to the wheel (ME_Tq_sp_whl) on the basis of the delay coefficient a representative of the deviation between the sending of a torque setpoint of the electric machine related to the wheel and its actual application.

According to the invention, a mechanical braking torque setpoint at the wheels at the instant t is first of all defined: BRK_Tq_sp_raw(t). This setpoint is an unsaturated raw mechanical braking torque setpoint, that is a function of the type of control of the electric machine SCM_Ctrl_ typ and of the time of the end of ratio upshift or downshift T_{f} at the box. Depending on the type of control, BRK_Tq_sp_raw(t) is defined as follows.

If there is no control [SCM_Ctrl_typ(t)=no control], then the unsaturated mechanical braking setpoint is nil: BRK_Tq_sp_raw(t)=0.

If the electric machine is torque-controlled [SCM_Ctrl_typ(t)=torque control], and as long as the time t is prior to the end of upshift or downshift [t<Tf], the unsaturated mechanical braking torque setpoint BRK_Tq_sp_raw(t) is equal to the difference between the anticipated time of torque request to the electric machine and the estimation of the torque at the wheel at

t: BRK_Tq_sp_raw(t)=ME_Tq_sp_whl_ant(t)−ME_Tq_esti_whl(t).

If the electric machine is torque-controlled [SCM_Ctrl_typ(t)=torque control], and as soon as the time t is later than or equal to the end of upshift or downshift [t>=Tf], the setpoint is nil: BRK_Tq_sp_raw(t)=0.

If the electric machine is speed-controlled [SCM_Ctrl_typ(t)=speed control], and as long as the time t prior to the time of end of upshift or downshift [t<Tf], the unsaturated mechanical braking setpoint is equal to the anticipated torque setpoint related to the wheel:

BRK_Tq_sp_raw(t)=ME_Tq_sp_whl_ant(t).

If the electric machine is speed-controlled [SCM_Ctrl_typ(t)=speed control], as soon as the time t is later than or equal to the end of upshift or downshift [t>=Tf], the unsaturated mechanical braking setpoint is nil: BRK_Tq_sp_raw(t)=0.

In other words, the mechanical braking setpoint BRK_Tq_sp_raw(t) is nil when the electric machine is not controlled, before the upshift or downshift request T0 and after the end of ratio upshift or downshift Tf. Before the end of upshift or downshift, it is equal:

to the difference between the anticipated torque request to the electric machine and the estimation of the torque anticipated at the wheel BRK_Tq_sp_raw(t)=ME_Tq_sp_whl_ant(t) ME_Tq_esti_whl(t), if the electric machine is torque-controlled, and

to the anticipated torque setpoint related to the wheel ME_Tq_sp_whl_ant(t), if the electric machine is speed-controlled.

There is a switch from the unsaturated mechanical braking torque setpoint BRK_Tq_sp_raw(t) to the mechanical braking torque setpoint BRK_Tq_sp(t), through the following relationships:

if BRK_Tq_sp_raw(t)>0, BRK_Tq_sp (t)=0

if BRK_Tq_sp_raw(t)<=0, BRK_Tq_sp(t)=BRK_Tq_sp_raw(t).

If the estimation of the torque of the electric machine ME_Tq_esti is not available at the instant t, the invention provides for using the delayed torque setpoint related to the wheel, ME_Tq_sp_whl_delay, as a basis for calculating the estimation of the torque at the wheel ME_Tq_esti_whl. It becomes:

ME_Tq_esti_whl (t)=ME_Tq_sp_whl_delay(t),

with a delay limited for example to 0.05 second:

0<t_delay<=0.05 s.

FIG. 2 shows, in simulation, the advantage of the proposed solution, which compensates for the lack of deceleration of the vehicle during a change of ratio. In this example, the acceleration of the vehicle before the change of ratio is −1.2 m/s. Without the invention (broken line curve), the braking torque of the electric machine decreases without compensation from the ratio upshift or downshift request at T0. The acceleration of the vehicle simultaneously leaves its initial value to rise to zero, before dropping back again over a gentler slope to said initial value. With the invention (solid line curve), the vehicle acceleration remains at its value of -1.2 m/s², during the change of ratio.

1-9. (canceled)

10. A method for compensating for an interruption of torque at a wheel in the event of a change of ratio in braking on a vehicle having an electric traction machine linked to wheels of the vehicle by a gearbox that can transmit to the wheels a braking torque of the electric machine in a phase of deceleration over at least two transmission ratios, and a mechanical braking system acting on the wheels independently of the electric machine, the method comprising:
defining a setpoint of mechanical braking torque at the wheels, as a function of a type of control of the electric machine, and of a time of a ratio downshift request to the gearbox the mechanical braking torque setpoint which is equal at an instant to a difference between an anticipated torque request to the electric machine and an estimation of the torque at the wheel, before a time of an end of the shift at the gearbox, if the electric machine is torque-controlled.

11. The method for compensating for a torque interruption as claimed in claim 10, wherein the mechanical braking setpoint is nil when the electric machine is not controlled.

12. The method for compensating for a torque interruption as claimed in claim 10, wherein the mechanical braking torque setpoint is nil after the time of the end of ratio downshift or upshift.

13. The method for compensating for a torque interruption as claimed in claim 10, wherein the mechanical braking setpoint at the instant is equal to an anticipated torque setpoint related the wheel, before the time of the end of the downshift or upshift at the gearbox, if the electric machine is speed-controlled.

14. The method for compensating for a torque interruption as claimed in claim 10, wherein the estimation of the torque of the electric machine related to the wheel is the product of an estimation of the torque produced by the electric machine by the reduction ratio to the wheels.

15. The method for compensating for a torque interruption as claimed in claim 14, wherein, if an estimation of the torque of the electric machine is not available at the instant, the estimation of the torque at the wheel is based on a delayed torque setpoint related to the wheel.

16. The method for compensating for a torque interruption as claimed in claim 15, characterized in that the delay is less than 0.05 s.

17. The method for compensating for a torque interruption as claimed in claim 10, wherein the mechanical braking torque setpoint is an unsaturated raw setpoint.

18. The method for compensating for a torque interruption as claimed in claim 10, wherein the torque setpoint (BRK Tq_sp(t) is linked to the unsaturated mechanical braking torque setpoint BRK_Tq_sp_raw(t) by the following relationships:
if (BRK_Tq_sp_raw(t))>0, (BRK_Tq_sp(t)=0, and
if (BRK_Tq_sp_raw(t))<=0, BRK_Tq_sp(t)=BRK_Tq_sp_raw(t).
